(19) United States
(12) Patent Application Publication
(10) Pub. No.: US 2009/0127305 A1
(43) Pub. Date: May 21, 2009

(54) Pick-up truck tool box with slide-up doors

(76) Inventor: Dave A. Ropp, Tampa, FL (US)

Correspondence Address: Ropp Landscaping Service, 8890 Gerald St., Beaumont, TX, 77707, US

(21) Appl. No.: 11/985,495

(22) Filed: Nov. 15, 2007

(51) Int. Cl. B60R 9/00

(52) U.S. Cl. 224/404

(57) ABSTRACT

A pickup truck toolbox device is accessed from the sides of the truck through side sliding doors that open and close simultaneously and lock down. The toolbox provides a rolling tray that slides toward the user for easy access to material stored in the tray, or away from the user, and partially out the far opening, to allow for access to a large storage area below the tray. The tray also converts to a rolling cart to transport tools and material to an area away from the truck. The entire toolbox sits on the side rails of the truck and is elevated above the bed of the truck, keeping the bed free for transport of longer items.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to cargo boxes for trucks and particularly to a pick-up truck tool box which comprises a rectangular cargo holding box arranged for mounting across the side rails of a pickup truck to extend across the width of the truck near the cab of the truck with side openings to allow a sliding and removably replaceable tray which is mounted on tracks and slides out just above the side rails of the truck, an upper shell which houses the sliding tray and a pair of upwardly sliding single-panel doors and a lower cargo storage area below the sliding tray, a pulley and cable system which allows two flexible door panels to raise to open and lower to close simultaneously with the door panels receding up under the roof of the tool box within the shell to open the doors.

2. Description of Related Art Including Information Disclosed Under 37 CFR 1.97 and 1.98

The cargo carrying area of a pickup truck is often referred to as the “bed”. During certain types of transport it is necessary to include a storage container in a vehicle's bed to hold tools, equipment, supplies, or other items to which ready and convenient access is necessary or desirable. It is common to use a bed mounted toolbox, also referred to as a “utility box,” to enclose and protect tools and materials from both theft and weather related damage. Most tool boxes include an upwardly pivoting front lid that provides access to the interior storage space with an outside padlock. These prior art tool boxes can be broken into easily and they do not provide for easy access to the contents from the sides of the pickup.

U.S. Pat. No. 6,814,384, issued Nov. 9, 2004 to Grafton, is for a sliding tray trunk for a vehicle having a lower storage box, an upper storage box slidably attached on top of the storage box, a locking cover that secures the upper storage box over the lower storage box, and one or more stops to limit sliding of the upper storage box on the lower storage box to a predetermined distance is provided. The lower storage box has a substantially rectangular shape. The lower storage box has two rails on which the upper storage box can slide. A plurality of wheels are rotatably attached on each of the rails, and the upper storage box slides by rotation of the wheels.

U.S. Patent Application #20050110294, published May 26, 2005 by Grafton, illustrates a sliding tray trunk for a vehicle having a lower storage box, an upper storage box slidably attached on top of the storage box, a locking cover that secures the upper storage box over the lower storage box, and one or more stops to limit sliding of the upper storage box on the lower storage box to a predetermined distance. The lower storage box has a substantially rectangular shape. The lower storage box has two rails on which the upper storage box can slide. A plurality of wheels are rotatably attached on each of the rails, and the upper storage box slides by rotation of the wheels. Alternatively, the mounting base can include a security panel connected to the mounting base by braces and struts and rimmed with a seal.

U.S. Pat. No. 5,634,577, issued Jun. 3, 1997 to Pearson, Jr., claims an open bottom crossover tool box insert. A truck storage box device is provided for use in the bed of a pick-up truck, having a bottom, and a plurality of interconnected sides extending upward from the periphery of the bottom which intersect to provide an open top for access to the interior formed between the bottom and the sides. The bottom and sides form an open container in which a plurality of spaced pairs of opposed elongated rails extend horizontally along opposite interior wall portions thereof in a spaced relationship with the bottom. Each pair of opposed rails is arranged to slidably receive and support a number of elongated trays thereon. Each of the trays is arranged to extend between pairs of opposed rails. Collectively, the pairs of opposed rails form a vertical array in which a number of trays can be supported on each pair of opposed rails in a vertically stacked arrangement from which one or more intermediate trays may selectively be slid horizontally from within the stacked vertical arrangement for access to their particular contents. The box may be placed within a tool storage box, or a pair of spaced brackets may be provided which extend outwardly from the container for attaching the container to the bed of the pick-up truck, and hold the storage box in place in the bed of truck.

U.S. Pat. No. 5,823,605, issued Oct. 20, 1998 to Seargeant, describes a cover system for the truck box of a pickup truck that includes upstanding sides and front portion which define inwardly thereof an open area to be covered by a series of parallel edge to edge cover panels. The cover panels slide forwardly and rearwardly on a guide track and the guide track is divided at the front so that the panels form accordion folds in a fold section stored at the front of the structure. Two rear side parts at the rear of the cover can be pivoted about a a horizontal axis across the top. These rear portions carry a part of the guide track and a whole number of panels fill the area from the hinge to the bottom edge of the rear portion. Thus the rear portion can be pivoted about the hinge while the panels flex. Thus only a rear portion can be opened or the cover panels can be moved forwardly to various set locations or folded fully.

U.S. Patent Application #20020113106, published Aug. 22, 2002 by Cheney, puts forth a vehicle storage box that comprises a base structure; a lid, pivotally connected to the base structure, shaped to enclose the base structure; divider means, pivotally connected to the base structure, for dividing the storage box into two compartments for holding articles; divider coupling means, connected to the divider means and the lid, for releasably coupling the divider means to the lid; and lid coupling means, connected to the lid and the base structure, for releasably coupling the lid to the base structure, and having a first coupling position occurring when the lid is in an opened position. The lid coupling means also comprises a first and second lid actuator and a first and second lid latch wherein the first and second lid actuators are coupled together by a lid actuator connector for simultaneous operation of the first and second lid actuators. The divider coupling means further comprises a first and second divider actuator coupled to the lid and a first and second divider latch coupled to the divider means wherein the first and second divider actuators are coupled together by a divider actuator connector for simultaneous operation of the first and second divider actuators. The vehicle storage box according to the present invention also includes a single hinge connecting the base structure, the divider means and the lid, such that the lid and the divider means pivot around the same axis.

U.S. Patent Application #20050145527, published Jul. 7, 2005 by Christensen, concerns a tool box with enhanced weather protection for mounting on a truck bed, which includes a base component and a top component. The base component has a bottom, left side, right side, and a back, and has an open front and an open top. The base component has a first inside pivot assembly area on the left side and a second inside pivot assembly area on the right side. The top component has a top, back extending downwardly from the top, front extending downwardly from the top, left side, and a right side. The sides are connected to the back and the front and extend downwardly from the top. The top component has a first outside pivot assembly area on the left side and a second outside pivot attachment area on the right side. The top component has an overall width greater than the width of the base component so that the top component nests on top of the component and the left side and right side of the top component are exterior to the base component. There is a left pivot assembly and a right pivot assembly. The left pivot assembly is located at the first inside pivot assembly area and at the first outside pivot assembly area, and the right pivot assembly is located at the second inside pivot assembly area and at the second outside pivot assemble area, so that the top and bottom components are pivotally connected to one anther.

U.S. Pat. No. 6,386,409, issued May 14, 2002 to Cheney, provides a vehicle storage box with single hinged double secured compartments and dual actuating cam latches. The vehicle storage box includes a lid pivotally connected to a base structure, and a lid coupler to releasably couple the lid to the base structure. The lid coupler has a first coupling position occurring when the lid is in an opened position. The lid coupler includes a lid latch, a lid actuator, and a hooking cam coupled to the lid actuator to engage the lid latch while the lid is in an opened position. As the lid actuator is rotated, the lid latch tracks along the hooking cam of the lid actuator while the lid is pulled down. A divider can be pivotally connected to the base structure to divide the storage box into two compartments for holding articles. A single hinge can connect the base structure, the divider and the lid. The lid coupler can include first and second adjustable lid actuators coupled together.

U.S. Pat. No. 5,988,473, issued Nov. 23, 1999 to Hagan, shows a truck storage box apparatus having a base member which includes a lock loop. First and second storage compartment assemblies are supported by the base member and include first and second compartment regions. Sliding trays are positioned over the compartment regions. Hinged covers cover the sliding trays. Lock bars extend downward from distal edges of hinged covers which prevent the sliding trays from sliding outward when the hinged covers are closed. A third storage compartment assembly is supported by the base member and is located between the first and second storage compartment assemblies along a longitudinal axis. The third storage compartment assembly includes a plurality of drawers arrayed along a vertical axis, wherein each of the drawers includes a drawer handle. Each of the drawer handles is in linear alignment with the other drawer handles and the lock loop. One of the drawers, such as the bottommost drawer, includes internal divider walls for dividing an interior space in the one of the drawers into a plurality of smaller storage spaces. A locking pin is threaded through the drawer handles and the lock loop and is used for locking the drawers in a closed position. A padlock is provided for locking the locking pin into locking position with respect to the drawer handles. A first key lock assembly is connected to the first hinged cover, and a second key lock assembly is connected to the second hinged cover.

U.S. Pat. No. 4,511,173, issued Apr. 16, 1985 to Wentzel, provides a pickup truck cap having a roll-away or sectional overhead door in which the cap has a door frame at the rear thereof with a depending portion adapted to fit in the tailgate receptor portion of the truck bed. The guides for the door comprise channel members of tubular cross-section having a longitudinal side opening facing the door which is provided with apposed, narrow, rolling surfaces and the door is provided with rollers adapted to roll on these rolling surfaces. The rollers have a flange to prevent them from pulling out of the channel and are spring-biased to accommodate rocking of the truck.

U.S. Pat. No. 4,848,626, issued Jul. 18, 1989 to Waters, concerns a tool or utility box which is constructed to provide maximum flexibility in storing articles therein. The body of the container comprises side walls having inwardly directed ribs and ledge portions for slidably supporting a tray assembly. Smaller compartments may be formed within the interior of the container by using specially constructed dividers that cooperate with the inwardly directed ribs. The height of the dividers is less than the length of the side walls so that articles may be supported above the compartments formed by the dividers. Further, the construction of the container walls and tray assembly permits various sizes and types of articles to be stored and segregated within the container.

What is needed is a toolbox for a pickup truck which mounts behind the cab across the side rails of the pickup with room under the box for loading long items on the bed of the truck, the toolbox having side openings for easy access from either side of the truck without climbing onto the truck bed and vertical sliding doors which lock securely, and a removable interchangeable sliding tray for tools and equipment and supplies so that the toolbox is easy to use and locks securely.

### BRIEF SUMMARY OF THE INVENTION

An object of the present invention is to provide a toolbox for a pickup truck which mounts behind the cab across the side rails of the pickup with room under the box for loading long items on the bed of the truck, the toolbox having side openings for easy access without climbing onto the truck bed and vertical sliding doors which lock securely, and a removable interchangeable sliding tray for tools and equipment and supplies so that the toolbox is easy to use and locks securely.

Another object of the present invention is sliding doors that open simultaneously to allow the sliding tray to be pushed partially out one door providing access to materials in the lower section of the toolbox from the other door.

Another object of the present invention is sliding doors that slide into the frame when closed, providing more security than hinged doors.

Another object of the present invention is that the toolbox rests on the side rails of the truck and is elevated above the bed of the truck with enough space below the toolbox for storage of larger items on the bed of the truck.

Another object of the present invention is folding legs on the sliding tray to keep the tray properly elevated when removing from toolbox.

Another object of the present invention is rollers on the bottom of the tray and bottom of the folding legs of the tray to allow easy sliding within the toolbox and ease of rolling the tray after removal to the worksite.

In brief, the present invention is a toolbox for a pickup truck comprising a rectangular shaped box with a formed roofing material that is cut to form a sporty flange on the rear and a contour cut at the front that closely fits the rear of the cab contour. The doors are located on the sides and are made from a LEXAN® material that is approximately 1/16th of an inch thick. The doors slide up into the roof of the box. A cylindrical roller located at the top of the door opening provides the fulcrum that the doors roll over and holds the doors in place in both the open and closed position. Inside the box are two tracks that run parallel to each other and perpendicular to the side of the truck. These tracks facilitate a rolling tray that rolls out either side for access to its contents. This tray can be exchanged for a variety of other trays should the operator wish to change contents completely. In other words the tray can slide all the way out and another one put in its place if so desired. Below the tray and below the gunnels of the truck bed is a cargo hold similar to any other common crossover box. In addition, a lightweight cable runs through two pulleys so that the top of each door is attached to the bottom of the other door. Thus, when either one of the doors is opened the cables connected to the top of the other door opens the other door. When either door is closed the cable connected to the bottom of the other door closes the other door. The doors lock down securely and provide more security than regular doors because there are no hinges to break through. The door may be operated with a power door opener similar to a garage door.

The toolbox mounts to the back of a pickup truck with bolts or brackets to secure the box on the back of the pickup truck behind the cab. The toolbox rests on the side rails of the pickup truck and attaches to the side rails so that there is a space below the toolbox for carrying long items on the bed of the pickup truck.

Everything loads from the sides of the truck through the roll up doors. A tray for tools and equipment and supplies rolls out either side through the side doors. The tray can be completely removed and carried on a rolling cart to the job site. Trays are replaceable with other trays preloaded with equipment or supplies or tools for whatever the job or recreational activity requires.

Below the tray is a bottom cargo hold in the toolbox for storing items which are accessed by sliding the tray out of the way and reaching down below the level of the tray.

An advantage of the present invention is easy access from the side of the truck, eliminating the need to climb onto the bed of the truck to access the toolbox.

Another advantage of the present invention is added security provided by sliding doors, eliminating hinges that can be broken during a theft.

Another advantage of the present invention is ease of use provided by rollers on bottom of the tray, allowing it to slide back and forth within the toolbox.

Another advantage of the present invention is easy access to materials stored on and below a sliding tray, as the tray can be slid toward a person for easy access to materials stored on the tray, or slid away and partially out of the other door in order access items in storage area below.

Another advantage is that the doors open simultaneously, when one is opened the other automatically opens, eliminating the need to walk around the truck to open it in order to slide the tray out of the way of items below.

Another advantage of the present invention is ease of use provided by the tray's folding legs with rollers at the bottom of each leg. These legs with rollers allow the tray filled with tools to be easily transported to the job site.

Yet another advantage of the present invention is that the bed of the truck can still be used for transportation of larger and longer items, as the toolbox rests only on the side rails of the truck and is elevated above the bed.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a partial perspective view of the pickup toolbox of the present invention mounted between the side rails of a pickup truck;

FIG. 2 is an exploded perspective view of the components of the pickup toolbox of the present invention aligned for assembly;

FIG. 3 is a perspective view of the assembled components of the pickup toolbox of the present invention with the cover removed, the sliding doors down, and the tray inside the toolbox;

FIG. 4 is a perspective view of the assembled components of the pickup toolbox of the present invention with the cover removed, the sliding doors up, and the tray partially outside the toolbox;

FIG. 5 is an elevational view of the back of a pickup truck having the pickup toolbox of the present invention mounted between the side rails of the pickup truck and the slide-out storage tray partially out of the toolbox with one of the fold-out legs extended down;

FIG. 6 is a perspective view of the slide-out tray assembly of the present invention removed from the pickup truck with the legs and rollers extending downwardly for rolling the tray independently of the pickup truck.

### DETAILED DESCRIPTION OF THE INVENTION

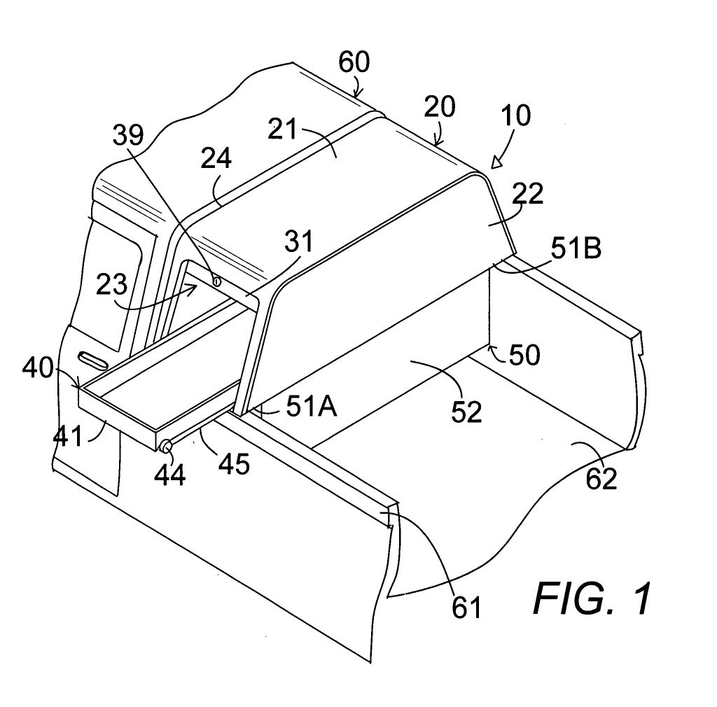

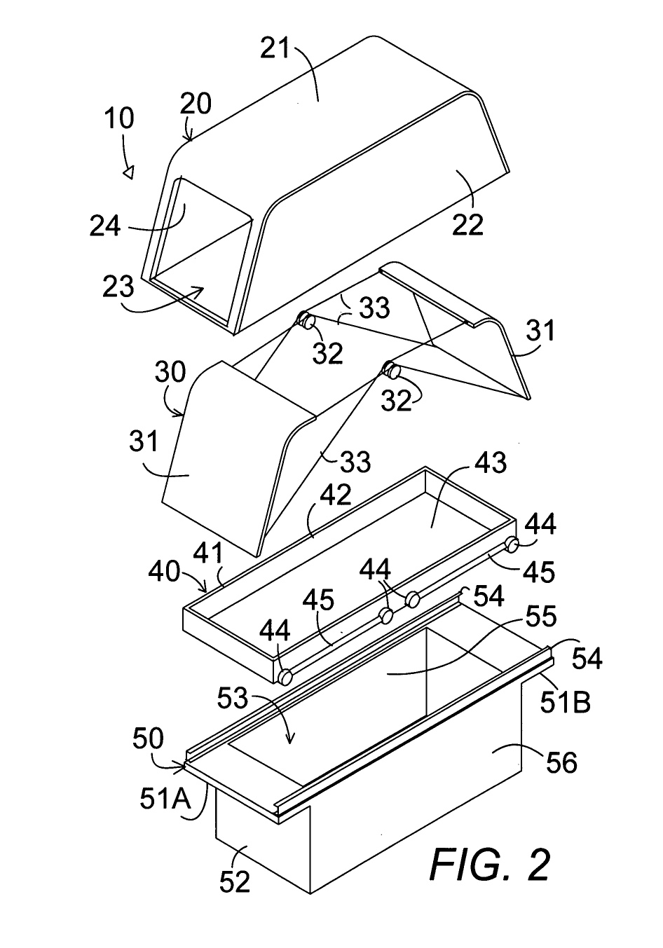

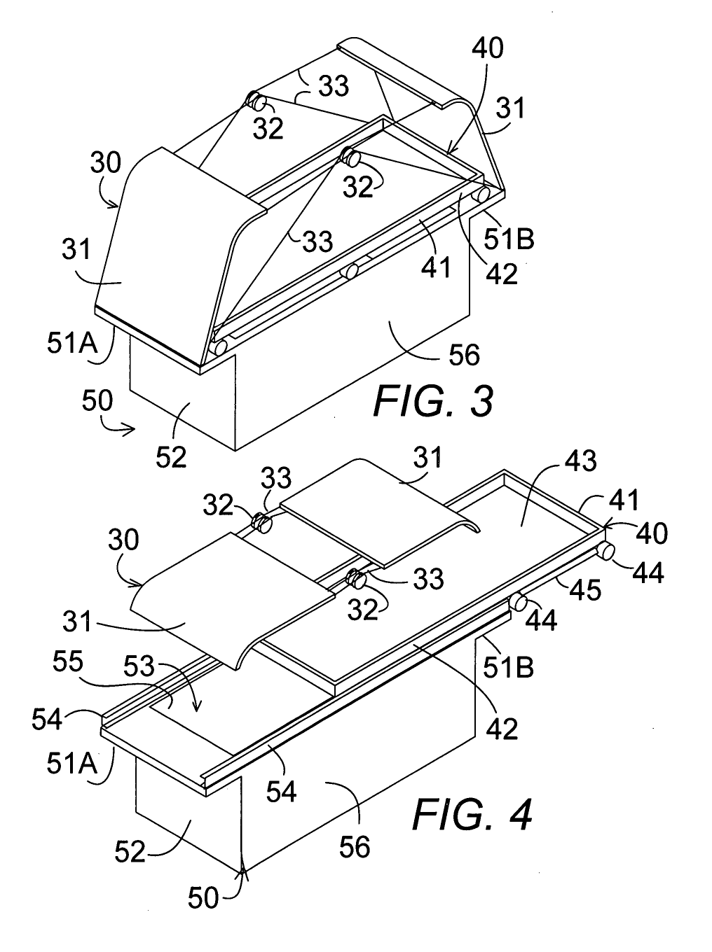

In FIGS. 1-6, a toolbox device 10 for a pickup truck 60 is an enclosed toolbox structure with a top impenetrable roof 20 with sliding vertical doors 31 covering side openings 23. These openings are above the side rails 61 of the pickup truck 60. The toolbox contains a bottom storage box 50 having a pair of wings 51A and 51B that sit on the side rails 61. Tray rails 54 run perpendicular to side rails to receive rollers 44 from a sliding tray assembly 40 with fold-out legs 45 with bottom rollers 44, so that the sliding tray assembly 40 rolls partially out of the toolbox for access to items in the tray 41 or the bottom storage space 52 in the bottom storage box 50. The storage tray alternately rolls all the way out of the toolbox device to roll on fold-out legs 45 with bottom rollers 44 to a desired location away from the pickup truck.

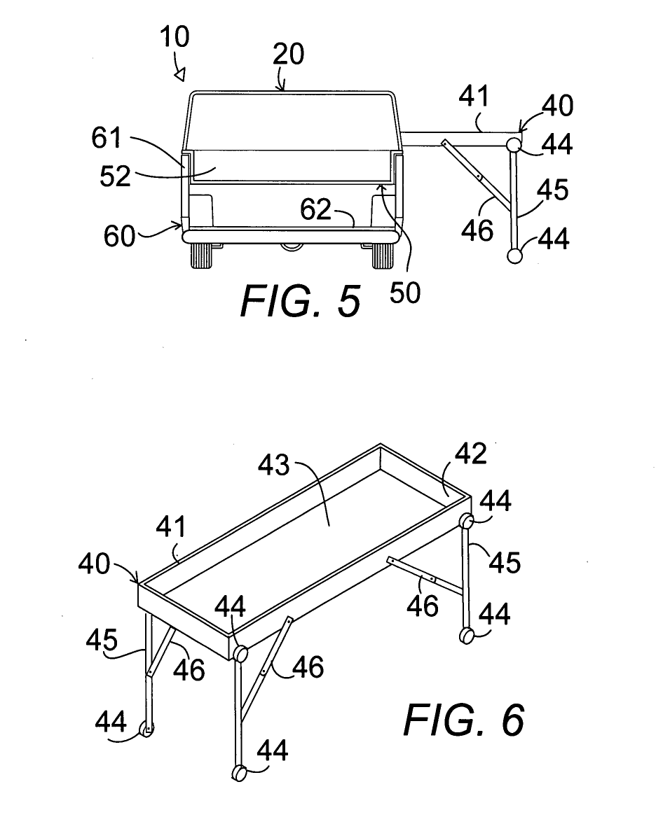

The toolbox structure has an impenetrable outer shell 20 made from a formed roofing material that is cut to form a sporty flange,on the rear and a contour cut at the front that closely fits the rear of the cab contour, and a bottom storage box 50 that fits between two opposing side rails of a pickup truck bed. The toolbox cover 20 has an impenetrable roof 21 and an impenetrable upper front wall 24 and upper back wall 22 contiguous with an impenetrable lower front wall 56 and lower back wall 55 of the bottom storage box 52. There are wings 51A and 51B extending laterally beyond the bottom storage box 50 on each end. These wings rest on and mount to each of the side rails 61, FIG. 5 of the pickup truck 60, FIG. 5 with the bottom storage space elevated above the pickup truck bed to allow storage of long items on the pickup truck bed below the toolbox FIG. 5. There is an opening 23 above each wing 51A and B that is accessible from the side of the pickup truck. The openings 23 communicate with an interior space 53 inside the bottom storage box 50 and a contiguous interior space within the cover of the toolbox 20.

The toolbox 10 mounts to the back of a pickup truck 60 with bolts or brackets to secure the box on the back of the pickup truck behind the cab. The toolbox rests on and attaches to the side rails 61 of the pickup truck so that there is a space below the toolbox for carrying long items on the bed of the pickup truck 62.

There is a pair of upwardly sliding flexible panel doors 31 which slide inside each of the openings 23 above the wings. These flexible panel doors 31 have a pulley and cable system 32 and 33 interconnected to them which allow the pair of flexible panel doors to raise to open and lower to close, both doors opening and closing simultaneously. The door panels 31 recede up under the roof of the toolbox 21 within the shell when the doors are opened. The doors are located on the sides and are made from a LEXAN® material that is approximately 1/16th of an inch thick. A cylindrical roller located at the top of the door opening provides the fulcrum that the doors roll over and holds the doors in place in both the open and closed position.

A storage tray 40 is mounted with rollers 44 on tray rails 54 that are connected between the two wings 51A and B and run parallel to each other and perpendicular to the side of the truck, so that the storage tray rolls out either opening 23, at least partially extending out of the toolbox structure FIG. 4 for accessing the contents of the rolling storage tray 40 or the lower storage compartment 52 beneath the storage tray.

The storage tray 40 also has a folding pair of legs 45 with rollers 44 at each end of the tray. These legs fold up flat against the storage tray when used in the toolbox structure, the rollers running along the tray rail FIGS. 1-4. The legs also fold down perpendicular to the storage tray to transport the storage tray to another location separate from the toolbox, the rollers serving as wheels at the end of the legs, converting the storage tray to a rolling cart, FIGS. 5-6.

A locking mechanism 39 FIG. 1 is on each of the flexible panel doors 31 and locks with the doors in a closed down position to secure the contents of the storage tray within the toolbox structure.

In use: To access contents of the toolbox, one of the doors slides up by lifting it to allow access through the opening and engaging the other door to do the same through a series of cables and pulleys. Once the doors are open, the operator may then either access items in the sliding tray by pulling the tray toward them for easy access, or sliding the tray away from them, and partially out the far opening, exposing the contents of the storage area underneath the tray for access to those items.

Everything loads from the sides of the truck through the roll up doors. A tray for tools and equipment and supplies rolls out either side through the side doors. The tray can be completely removed and pushed as a rolling cart to the job site. Trays are replaceable with other trays preloaded with equipment or supplies or tools for whatever the job or recreational activity requires. Below the tray is a bottom cargo hold in the toolbox for storing items which are accessed from one side while the tray protrudes out of the other side of the truck.

A lightweight cable runs through two pulleys so that the top of each door is attached to the bottom of the other door. Thus, when either one of the doors is opened the cables connected to the top of the other door opens the other door. When either door is closed the cable connected to the bottom of the other door closes the other door. The doors lock down securely and provide more security than regular doors because there are no hinges to break through. The door may be operated with a power door opener similar to a garage door.

The toolbox device rests and is secured entirely on the side rails of the truck and is elevated above the bed of the truck, allowing for ample transport of longer items in the truck bed.

It is understood that the preceding description is given merely by way of illustration and not in limitation of the invention and that various modifications may be made thereto without departing from the spirit of the invention as claimed.

### Sequence Listing

Not Applicable.

What is claimed is:

1. A toolbox device for a pickup truck, the device comprising:
a toolbox structure comprising an impenetrable outer shell having a bottom storage box to fit between two opposing side rails of a pickup truck bed and a top mounting and access structure having an impenetrable roof and an impenetrable upper front wall and upper back wall contiguous with an impenetrable lower front wall and lower back wall of the bottom storage box and a wing extending laterally beyond the bottom storage box on each end for each wing to rest on and mount to one of the side rails of the pickup truck with the bottom storage space elevated above the pickup truck bed to allow storage of long items on the pickup truck bed below the toolbox, an opening in each wing over each side rail accessible from the side of the pickup truck, the openings communicating with an interior space inside the bottom storage box and a contiguous interior space within the top mounting and access structure;
a storage tray mounted with rollers on rails connected between the two wings so that the storage tray rolls out either opening at least partially extending out of the toolbox structure for accessing the contents of the storage tray;
a pair of upwardly sliding flexible panel doors comprising a vertically slidable door in each of the openings in the wings and a pulley and cable system interconnected with the pair of flexible panel doors which allows the pair of flexible panel doors to raise to open and lower to close simultaneously with the door panels receding up under the roof of the tool box within the shell to open the doors.

2. The device of claim 1 wherein the storage tray further comprises a folding pair of legs with rollers at each end of the tray so that the pair of legs folds up flat against the storage tray for use of the tray in the toolbox structure and the pair of legs folds down parallel to the storage tray with the tray separated from the toolbox structure to transport the storage tray to a location associated with the use of the contents of the storage tray.

3. The device of claim 1 further comprising a means for locking the pair of flexible panels doors in a closed down position to secure the contents of the storage tray within the toolbox structure.
